(19) United States
(12) Patent Application Publication
(10) Pub. No.: US 2017/0347638 A1
(43) Pub. Date: Dec. 7, 2017

(54) HORSE CARE APPARATUS

(71) Applicant: Samuel McKee, Ocala, FL (US)

(72) Inventor: Samuel McKee, Ocala, FL (US)

(21) Appl. No.: 15/615,503

(22) Filed: Jun. 6, 2017

Related U.S. Application Data
(60) Provisional application No. 62/346,397, filed on Jun. 6, 2016.

(51) Int. Cl. A01L 15/00; A01L 3/04; A01L 11/00; A61D 3/00

(52) U.S. Cl. CPC A01L 15/00; A01L 11/00; A01L 3/04; A61D 2003/006

(57) ABSTRACT

A hoof care apparatus is comprised of a generally cup-shaped body comprising a cylindrical side wall having an outer surface and an inner surface, the inner surface being sized and shaped for the receipt of and mating engagement with the bottom rim of a cylindrical dispenser containing a liquid hoof care product; and a tongue projecting radially from the outer surface of the side wall of the cylindrical body which serves as a hoof pick. The dispenser can be supported by the apparatus on a surface in an upright position when not in use.

### RELATED APPLICATION

This application claims the benefit of U.S. Provisional Application No. 62/346,397 filed Jun. 6, 2016 and entitled, Hoof Care Apparatus.

### FIELD OF THE INVENTION

The present invention relates generally to a hoof care apparatus for use on horses, donkeys, mules and other hooved animals, and more specifically to an accessory apparatus for attachment to dispensers for various hoof care and grooming products such as fungicides, antiseptics, hoof dressings, polishes and the like.

### BACKGROUND OF THE INVENTION

Hoof care is especially important when caring for the horse as an aid in preventing both short or long-term soundness issues. The most basic form of hoofcare is cleaning, or “picking out” of the feet. A hoof pick is typically comprised of a hooked or angled prong attached to a handle and is used to remove mud, clay, sand, small stones, manure, snow and other such foreign matter from the sole of the hoof. Removal of mud, manure and other damp matter helps to prevent thrush, a common hoof ailment which in very severe cases may cause lameness, and the removal of rocks and stones helps to prevent bruises. Another benefit of regularly picking out and cleaning a horse's feet is that they may be visually inspected for problems such as puncture wounds and torn frogs. When picking a horse's feet, all crevices of the hoof are cleaned, particularly the sulci between the frog and the bars, as those areas are most likely to trap rocks or other debris, and also are the most common area to develop thrush.

Despite the benefits of regular picking of the horse's feet, the task can be both time consuming and frustrating. Usually, the caregiver places the hoof care tools and products to be used in close proximity to the foot to be cleaned and/or treated and then relocates them from hoof to hoof working his or her way around the horse. To perform the task, the caregiver stands at the horse's side, facing the tail of the horse. For well trained horses, simply sliding a hand down the horse's leg serves as a request for the horse to lift its hoof which the caregiver then supports with one hand while cleaning the hoof with the other hand. For less trained horses, or horses that are fearful, unsound or disobedient, a gentle pinching of the tendons above the fetlock will cause the horse to yield its foot. In some cases, more extreme measures are required. Depending on the training, disposition and/or soundness of the horse, the task of cleaning and treating each hoof can range from being relatively effortless to being extremely physical and demanding for the caregiver. Particularly in those instances where lifting of the hooves is more challenging, the level of difficulty is compounded when the horse moves from its original standing location to a new location. Even when moving only a relatively short distance such as a few feet, it can be enough to place the cleaning tools and products out of reach. When both picking and dressing the bottom of the horse's feet, it is not uncommon to have to lift and lower each foot several times for the purpose of alternately fetching the pick and the product to be applied. In an effort to simplify this task, an apparatus that combines both a hoof pick and a hoof dressing applicator is known in the art. Specifically, U.S. Pat. No. 5,168,935 issued to Thornbury et al. teaches a hoof pick comprising a hollowed handle for the storage of liquid hoof dressing. A dressing dispensing applicator is located at the end of the handle opposite the pick end. The Thornbury et al. apparatus suffers from what may be considered by some to be significant shortcomings. Because the pick blade depends from a shaft or “anchor section” that projects axially from the handle, the apparatus as a whole cannot be stood up on end. Accordingly, the pick must be laid on its side which can lead to leaking of the fluid contents from the applicator, or clogging of the applicator. Additionally, the dressing fluid must be poured from its original container into the hollowed handle of the pick which only holds a relatively small volume and must be replaced frequently.

All patents, patent applications, provisional applications, and publications referred to or cited herein, or from which a claim for benefit of priority has been made, are incorporated herein by reference in their entirety to the extent they are not inconsistent with the explicit teachings of this specification.

### SUMMARY OF THE INVENTION

Accordingly, it is a primary object of the present invention to provide a single tool incorporating both a hoof pick and hoof dressing dispenser with hoof dressing wherein the pick blade is substantially normal to the longitudinal axis of the dispenser and the apparatus is capable of standing on end.

It is another primary object of the subject invention to provide a shankless hoof pick including a mounting cavity for receiving in mounting engagement the bottom of a cylindrical hoof dressing dispenser such as an aerosol can containing a hoof dressing.

Still another primary object of the subject invention is to provide a combination hoof pick tool and hoof dressing dispenser wherein the dressing dispenser is a conventional aerosol can or pump spray bottle and serves as the handle for the hoof pick.

Another object of the subject invention is to provide a hoof care apparatus that facilitates the picking and cleaning of a hoof bottom in a more efficient manner than employing two separate tools for this purpose.

Another object of the subject invention is to provide a hoof pick apparatus for attachment to a hoof dressing applicator wherein the hoof pick apparatus is relatively simple in design and therefore capable of rapid construction at relatively low costs.

These together with other objects of the invention, along with the various features of novelty which characterize the invention, are pointed out with particularity in the claims annexed to and forming a part of this disclosure, and will become readily apparent to those skilled in the art upon consideration of the drawings and detailed description below.

By way of summary, the above recited objects of the present invention, as well as others, are obtained by the provision of a shankless hoof pick apparatus attachable to a conventional aerosol can containing a hoof care product such that the can serves as the handle for the pick and the pick does not prevent resting the can upright on end in the usual manner.

According to one aspect of the present invention there is provided a shankless hoof pick tool for temporary attachment to the bottom of an aerosol can containing a hoof care product, the apparatus being comprised of two primary components, namely 1) a generally cup-shaped body having an outer wall, preferably but not essentially, round in cross-section, and an inner wall defining a cavity, the cavity being sized and shaped for the receipt of and mating engagement with the bottom of a conventional aerosol can, and 2) a tongue projecting generally radially from the outer wall of the body, the tongue being generally wedge shaped having blunt sides that can be used for scraping off debris from the outer wall of a horse's hoof and further including a tip for insertion under the debris to be removed from the horse's hoof. By means of this construction is provided a shankless hoof pick apparatus for use in conjunction with an ordinary aerosol can containing a hoof care product wherein the can body serves as the handle of the pick and the pick apparatus may be removed from the can and reused. According to another aspect of the present invention there is provided a combination hoof pick tool and hoof care product dispenser wherein the hoof pick tool is permanently attached to the bottom of the aerosol can.

There has thus been outlined, rather broadly, the more important components and features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

For a better understanding of the invention, its advantages and the specific objects attained by its uses, reference should be had to the accompanying drawings and descriptive matter in which there is illustrated a preferred embodiment of the invention

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side perspective view of the hoof care apparatus of the present invention;

FIG. 2 is a plan view of the hoof care apparatus of FIG. 1;

FIG. 3 is a bottom view of the hoof care apparatus of FIG. 1; and

FIG. 4 is a side perspective view of the present invention attached to a typical aerosol can.

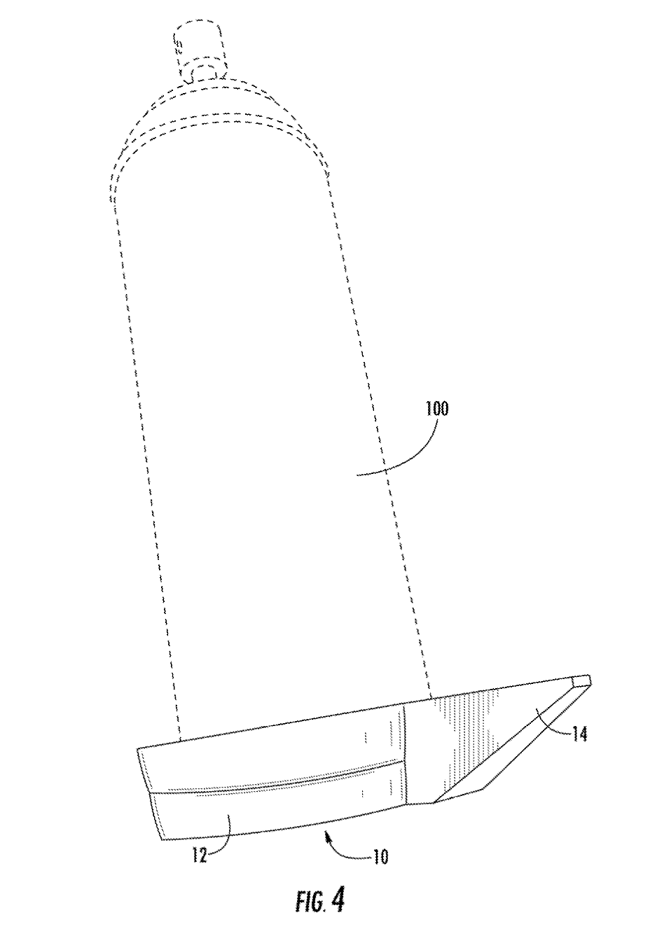

### DETAILED DESCRIPTION OF THE PREFERRED EMBODIMENT

It should be clearly understood at the outset like reference numerals are intended to identify the same structural elements, portions or surfaces consistently throughout the several drawings herein, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. It should also be noted that in order to promote clarity and ease of understanding by the reader, or merely for ease of illustration, the figures are not drawn to scale and the proportions of certain parts have been exaggerated from one figure to the next. As used in the following description, any reference to terms of orientation such as “horizontal”, “vertical”, “front”, “rear”, “left”, “right”, “up”, “down”, “inward” or “outward”, “proximate”, “distal”, as well as adjectival and adverbial derivatives thereof (e.g., “horizontally”, “vertically”, “forwardly”, “rearwardly”, “leftward”, “rightward”, “upward”, “downward”, “inwardly” or “outwardly”), generally refer to the orientation of a surface or structure relative to its axis of elongation, or axis of rotation, as appropriate. One of ordinary skill in the art will also appreciate that a component may be designed as multiple components or that multiple components may be designed as a single component.

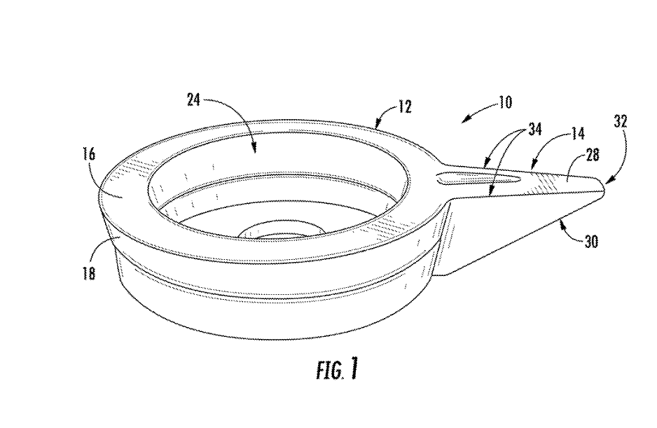

Reference is first made to FIG. 1 in which there is illustrated a side elevational view of the hoof care apparatus of the present invention designated generally by reference numeral 10. The apparatus is comprised of two primary components, namely a generally cup-shaped body 12 for attachment to a hoof care product dispenser 100 as herein described, and a generally wedge-shaped tongue 14 which is used for picking of a horse's hooves. Tongue 14 may be integrally formed with body 12 or may be a separate component attached thereto.

Hoof care product dispenser 100 (hereinafter more simply referred to as “dispenser 100”) is a container for the storage and dispensing of a liquid hoof care product. In one embodiment, dispenser 100 is of the aerosol can variety being constructed of thin metal such as either tinplate (tin-coated steel), tin-free steel or aluminum. Dispenser 100 is a circular cylinder typically with vertical sides although in some embodiments the sides may be tapered such that it is generally conical in shape. The fabrication of dispenser 100 results in a bottom “rim” at the base of the dispenser. The rim comprises a narrow ring having an outside diameter slightly larger than that of the rest of the dispenser. The top of the dispenser is typically dome-shaped and includes a dispensing valve there through and having an actuator or “button” for release of the fluid contents which are stored under pressure. Other forms of dispensers may also be used including non-aerosol alternatives. A lid may be either hingedly attached to the top of the dispenser or attached via friction fit.

Body 12 and tongue 14 are preferably but not essentially manufactured by an injection molding process using a variety of materials including metals (for diecasting), elastomers and thermoplastic and thermosetting polymers. Many different polymers or “resins” may be used including thermosetting plastics such as epoxy and phenolic, or thermoplastics such as nylon, polyethylene and polystyrene, provided they possess rigidity and hardness characteristics suitable for picking of hooves. In some embodiments a molded rubber or silicon may be used provided it has suitable resiliency and malleability for purposes herein described.

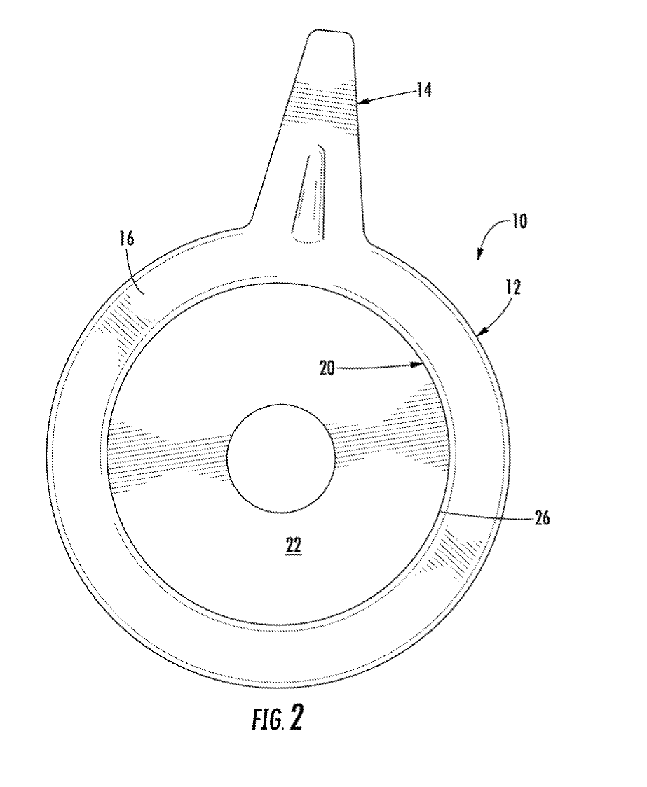

Body 12 is comprised of a cylindrical side wall 16, circular in cross section (FIG. 2), having an outer surface 18 that is either flat or tapered (as shown) and a thickness suitable for withstanding the torque and other forces associated with picking of hooves without breaking or cracking. Side wall 16 further includes an inner surface 20 terminating at its base in floor 22. Together, side wall 16 and floor 22 form a cavity 24 which is sized and shaped for the receipt of and mating engagement with the bottom of dispenser 100, and more specifically to the bottom rim thereof.

Mating engagement of the bottom rim of dispenser 100 within cavity 24 may be accomplished via an interference fit, also known as a press fit or friction fit wherein union of the two parts is achieved by friction after the parts are pushed together, rather than by any other means of fastening. Accordingly, the inner diameter of wall 16 is slightly less than the outer diameter of the bottom rim of dispenser 100. The top inner edge 26 of wall 16 may be chamfered (beveled) to form a guide for the pressing movement of the dispenser rim into cavity 24 thus helping the pressing operation to be smoother, more easily controlled and to require less force, and to assist in aligning the rim with the cavity. In alternate embodiments, the parts may be fastened permanently together using an epoxy or adhesive which essentially “welds” them together.

Tongue 14 projects generally radially from the outer wall of body 12 and, as stated, is generally wedge shaped having a top surface 28 extending normal to wall 16 of body 12, and a bottom surface 30 extending an acute angle relative to wall 16. Bottom surface 28 and top surface 30 merge at distal tip 32 of tongue 14 which is preferably but not essentially blunted. Top surface 30 further includes side edges 34 that can be used for scraping off debris from the outer wall of a horse's hoof.

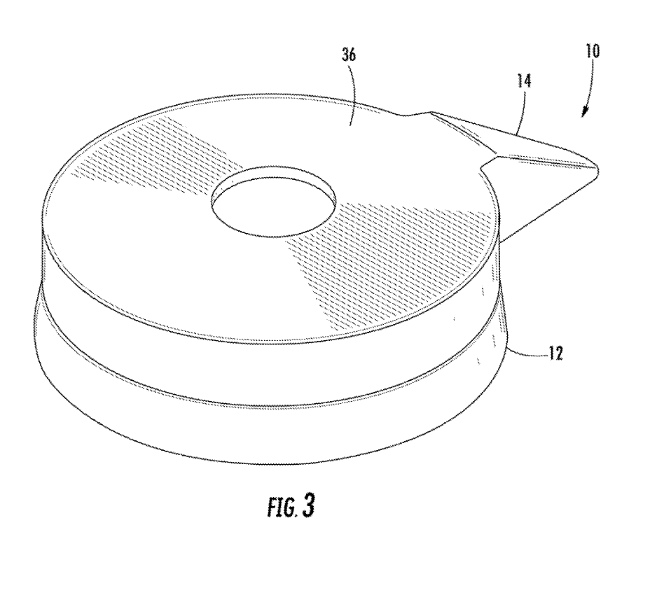

Reference being made to FIG. 3, it is important to note that the bottom 36 of floor 22 is flat so that when apparatus 10 is mounted to the bottom of the dispenser 100, the dispenser can be stood up on end to provide for easy storage and accessibility and to prevent its contents from spilling or fouling the applicator.

By means of the above described construction it should be appreciated that there is provided a shankless hoof pick apparatus for use in conjunction with an ordinary aerosol can containing a hoof care product wherein the can body serves as the handle of the pick. Hoof care apparatus 10 may be removably attached to the dispenser 100 and reused, or may be sold as a disposable unit when permanently attached to the dispenser.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A hoof care apparatus, comprising:
a. a generally cup-shaped body comprising a cylindrical side wall having an outer surface and an inner surface, said inner surface being round in cross-section and terminating in a floor, said inner surface and said floor defining a cavity, said cavity being sized and shaped for the receipt of and mating engagement with the bottom rim of a cylindrical dispenser containing a liquid hoof care product; and
b. a tongue projecting radially from said outer surface of said side wall of said body for removing debris from the hooves of equines.

2. The hoof care apparatus of claim 1, wherein said body and said tongue are integrally formed together.

3. The hoof care apparatus of claim 1, wherein said body and said tongue are separate components permanently joined together.

4. The hoof care apparatus of claim 1, wherein at least one of said body and said tongue is comprised of a polymer.

5. The hoof care apparatus of claim 1, wherein at least one of said body and said tongue is comprised of a metal.

6. A hoof care apparatus, comprising:
a. A cylindrical dispenser for a liquid hoof care product, said dispenser having a bottom rim at one end, and a dispensing applicator at the opposite end;
c. a cup-shaped body comprising a cylindrical side wall having an outer surface and an inner surface, said inner surface being round in cross-section and terminating in a floor, said inner surface and said floor defining a cavity, said cavity being sized and shaped for the receipt of and mating engagement with said rim of said cylindrical dispenser; and
b. a tongue projecting radially from said outer surface of said side wall of said body for removing debris from the hooves of equines,
whereby said dispenser may be supported by said body on a surface in an upright position.

7. The hoof care apparatus of claim 7, wherein said body and said tongue are integrally formed together.

8. The hoof care apparatus of claim 7, wherein said body and said tongue are separate components permanently joined together.

9. The hoof care apparatus of claim 7, wherein at least one of said body and said tongue is comprised of a polymer.

10. The hoof care apparatus of claim 7, wherein at least one of said body and said tongue is comprised of a metal.

11. The hoof care apparatus of claim 7, wherein said rim of said dispenser is pressure fitted to said inner surface of said side wall of said body.

12. The hoof care apparatus of claim 7, wherein said rim of said dispenser is bonded to said inner surface of said side wall of said body.
